(19) United States
(12) Patent Application Publication
(10) Pub. No.: US 2014/0132937 A1
(43) Pub. Date: May 15, 2014

(54) OPTICAL ELEMENT AND PROJECTION ARRANGEMENT INCLUDING SUCH AN OPTICAL ELEMENT

(71) Applicant: OSRAM GmbH, Muenchen (DE)

(72) Inventor: Martin Daniels, Berlin (DE)

(73) Assignee: OSRAM GmbH, Muenchen (DE)

(21) Appl. No.: 14/077,270

(22) Filed: Nov. 12, 2013

(30) Foreign Application Priority Data
Nov. 12, 2012 (DE) 10 2012 220 570.5

(51) Int. Cl. G03B 21/20; G02B 27/10

(52) U.S. Cl. CPC G03B 21/208; G02B 27/10
USPC 353/98; 359/629; 359/634

(57) ABSTRACT

In various embodiments, an optical element may include: a first planar base area; and a second planar base area; wherein the first base areas and second base areas do not lie in a same plane; wherein the first base area has a coating, which is designed to reflect or transmit an electromagnetic wave according to a predefined criterion; wherein the predefined criterion concerns a property of the electromagnetic wave which is different from an intensity; wherein a surface structure is arranged at the second base area of the optical element, said surface structure being formed integrally with the base area; and wherein the surface structure is designed to shape an intensity profile of a light beam impinging on the surface structure of the optical element.

### CROSS-REFERENCE TO RELATED APPLICATION

This application claims priority to German Patent Application Serial No. 10 2012 220 570.5, which was filed Nov. 12, 2012, and is incorporated herein by reference in its entirety.

### TECHNICAL FIELD

Various embodiments relate generally to an optical element and to a projection arrangement including such an optical element.

### BACKGROUND

Conventional projection arrangements usually include a wavelength conversion element in the form of a phosphor. In this case, said projection arrangements include an excitation light source, which excites the phosphor to emit light having a wavelength that is different from the excitation light wavelength. By means of suitable deflection of the excitation light and of the light emitted by the phosphor, these two light beams can be combined and fed to an integrator.

Such a conventional projection arrangement 10 is illustrated in FIG. 1. In this case, a laser diode array including a plurality of laser diodes 14 serves as the excitation light source 13. In this example, said laser diodes emit light in the blue spectral range. Via deflection minors 17, the light from said laser diodes 14 is directed onto a phosphor wheel 16, where it is converted into light having a different wavelength, such as, for example, into light in the red or green spectral range. Furthermore, the phosphor wheel 16 can have a small opening, such as, for example, in an edge region in which the phosphor is arranged, such that unconverted blue excitation light can pass through the phosphor wheel 16 without interaction therewith. By means of suitable deflection of this transmitted blue light, the latter can be combined with the conversion light emitted by the phosphor wheel 16, for which purpose in particular an integrator 22 can also be provided, onto which the combined beam bundle is directed. Furthermore, a dichroic mirror 12 is arranged in the beam path between the excitation light source 13 and the phosphor wheel 16, said dichroic minor being designed to transmit light in the blue spectral range and to reflect light in the non-blue spectral range. Moreover, even further optical elements, in particular in the form of lenses 20, are arranged in the beam path and essentially have a focusing and collimating effect.

In the case of arrangements having a phosphor for generating conversion light by excitation by means of an excitation radiation source, the pump light distribution on the phosphor should generally have an intensity profile that is as homogeneous as possible, in order to avoid or minimize so-called quenching. Quenching is a reduction of the conversion efficiency of the phosphor on account of increased power density (intensity quenching) and/or increased temperature (thermal quenching). Ideally, a sharply delimited “top hat” intensity profile would be required as pump light distribution on the phosphor.

A redistribution of the energy at the location of the phosphor can be achieved by means of light-scattering and/or beam-shaping optical elements in the beam path between source and phosphor. For this purpose, as can be seen in FIG. 1, two diffusers 24 and 26 are arranged in the beam path and each form an angle of 45° with the dichroic mirror 12. In this case, the first diffuser 24 serves for scattering the light emitted by the excitation light source 13, said light then being transmitted by the dichroic mirror 12 and impinging on the phosphor wheel 16. Furthermore, the second diffuser 26 is provided in order that unconverted excitation light, such as blue light, for example, which passes through the phosphor wheel 16 and is deflected by the further deflection mirrors 18 is further homogenized before combination with the red light, or in order to reduce speckle patterns that possibly occur in the application.

In the case of such projection arrangements, it is desirable, in principle, to configure them as efficiently as possible. In particular, the light losses should be kept as small as possible, the luminous efficiency of the phosphor should be as high as possible and the arrangement should be configured as compactly as possible. Since indeed the required optical elements are also very costly, a more cost-effective configuration is likewise desirable.

### SUMMARY

In various embodiments, an optical element may include: a first planar base area; and a second planar base area; wherein the first base areas and second base areas do not lie in a same plane; wherein the first base area has a coating, which is designed to reflect or transmit an electromagnetic wave according to a predefined criterion; wherein the predefined criterion concerns a property of the electromagnetic wave which is different from an intensity; wherein a surface structure is arranged at the second base area of the optical element, said surface structure being formed integrally with the base area; and wherein the surface structure is designed to shape an intensity profile of a light beam impinging on the surface structure of the optical element.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a conventional projection arrangement;

FIG. 2 shows a schematic illustration of a projection arrangement in accordance with various embodiments;

FIG. 3 shows a schematic and perspective illustration of the projection arrangement illustrated in FIG. 2 in accordance with various embodiments;

FIG. 4a shows a schematic illustration of the intensity distribution of the laser diode array illustrated in FIG. 2 in a cross-sectional plane along the line A;

FIG. 4b shows a schematic illustration of the intensity distribution of the laser diode array illustrated in FIG. 2 in a cross-sectional plane along the line B;

FIG. 5 a basic schematic diagram of the functioning of a lens array;

FIG. 6a shows a schematic illustration of an intensity distribution on a wavelength conversion element of a conventional projection arrangement without light-scattering and beam-shaping optical elements;

FIG. 6b shows a schematic illustration of an intensity distribution on a wavelength conversion element of a projection arrangement with an optical element having light-scattering properties in accordance with various embodiments;

FIG. 6c shows a schematic illustration of an intensity distribution on the wavelength conversion element of a projection arrangement with an optical element whose second base area has a surface structure embodied as a micro lens array, in accordance with various embodiments; and

FIG. 6d shows a schematic illustration of the intensity distribution on the wavelength conversion element of a projection arrangement with an optical element having a second base area having a micro lens array and additionally light-scattering properties, in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments provide an optical element which enables a projection arrangement to be configured as efficiently, compactly and cost-effectively as possible. Furthermore, various embodiments provide a projection arrangement which is as efficient, compact and cost-effective as possible.

Various embodiments are based on the insight that beam splitters that are customary in the prior art have on one area a coating which provides the beam splitting function, but that such optical elements, and in particular the further areas thereof, can be utilized for the provision of further optical functions.

The optical element according to various embodiments includes a first and a second planar base area, wherein the first and second base areas do not lie in a same plane. Furthermore the first base area has a coating, which is designed to reflect or transmit an electromagnetic wave according to a predefined criterion wherein the predefined criterion concerns a property of the electromagnetic wave which is different from an intensity. Furthermore, a surface structure is arranged at the second base area of the optical element, said surface structure being formed integrally with the base area. In this case, the surface structure is designed to shape an intensity profile of a light beam impinging on the surface structure of the optical element.

By virtue of the provision of a coating on the first side of the optical element, the latter can function as a beam splitter since the coating is designed to reflect or to transmit an electromagnetic wave according to a predefined criterion.

Various embodiments may thus make it possible, in a particularly advantageous manner, to utilize the second base area of the optical element for beam shaping or for shaping the intensity profile of a light beam that impinges on the second base area. A plurality of functions can thus be integrated into an optical element, which provides particularly cost-effective and compact arrangement possibilities for said optical element, particularly with regard to projection arrangements. Various embodiments may make it possible, firstly, to shape the intensity profile in terms of its dimensions, such as a length and/or a width, for example, whereby the geometrical configuration of an illumination region of an object can be predefined, such as an aperture ratio of 4:3 or 16:9, for example. Secondly, however, the intensity profile can also even be shaped itself in terms of its intensity progression, such that, for example, a homogenization of the intensity profile is possible and a “top hat” intensity profile can be provided, which is very advantageous particularly in applications in combination with a phosphor. By virtue of this design of the optical element with its extensive functional properties, in suitable applications, optical elements for beam shaping that have additionally been required heretofore can be omitted. This not only provides a large number of more compact and more cost-effective arrangement possibilities, but moreover also reduces the light losses, since the omission of additional optical elements also results in a reduction of the number of interfaces to be traversed at which undesired light scattering and reflection unavoidably occur.

In one configuration of various embodiments, the property concerns a wavelength or a polarization of the electromagnetic wave. In this regard, the optical element can function as a wavelength-selective beam splitter, for example, which transmits light in a first wavelength range and reflects light in a second wavelength range, which is different from the first wavelength range. For example in projection arrangements, an optical element designed in this way is particularly well suited since a wavelength-selective beam splitter, in particular for combining light of different wavelengths, is often required in such arrangements. Furthermore, for example for 3D projection arrangements operating on the basis of polarization, it may be particularly advantageous if the optical element is designed to reflect or to transmit light depending on its polarization, as a result of which the optical element can function as a polarization beam splitter. A combination of these configurations is also possible, of course, such that the optical element can be designed as a wavelength-selective polarization beam splitter. This affords a large number of application possibilities in which such an optical element may bring significant advantages.

In one configuration of various embodiments, the surface structure is designed in such a way that when light is incident on a region of the second area of the optical element, a deflection of the light with deflection angles which are location-dependent is brought about. This configuration may make it possible to bring about both light mixing of incident light and light scattering, which can be configured in a targeted or non-targeted manner. This may bring about beam shaping which enables both homogenization and shaping of the dimensions of the intensity profile.

In a further configuration of various embodiments, the surface structure of the second area of the optical element is designed to homogenize the intensity profile of a light beam impinging on the surface structure of the optical element.

As already mentioned, this homogenization may be advantageous in applications for exciting a phosphor. In such applications, the optical element makes it possible to obtain the highest possible luminance of the phosphor and to excite the latter right into the saturation range and at the same time to avoid so-called quenching. As a result of the homogenization, by way of example, a “top hat” intensity profile can also be provided, which constitutes an ideal pump light distribution on a phosphor for such applications. However, the design of the surface structure for homogenizing incident light also brings many advantages in a large number of other applications. By way of example, light can thus also be homogenized in order to smooth, reduce or completely eliminate interference patterns or speckle patterns of the intensity profile that are caused by scattering. These advantages of the homogenization can also be utilized at the same time, of course, in suitable applications, in particular in the case of a possible arrangement of the optical element in a beam path, such that repeatedly one beam passes through the optical element or a plurality of light beams pass through the optical element.

In one configuration of various embodiments, the surface structure of the optical element is designed in such a way that when light is incident on the surface structure, which light has a first intensity profile in a plane parallel to the second base area on a first straight line having a first length in a first direction, light emitted from the second base area has a second intensity profile on a straight line having the first length parallel to the first straight line, wherein a ratio of a sum of all deviations in terms of absolute values of the intensities from the mean intensity to the mean intensity of the first intensity profile is greater than that of the second intensity profile.

In other words, this is a more precise description of the beam shaping in the form of a homogenization or smoothing of the intensity profile. An intensity distribution of a light source usually has, depending on the configuration of the light source, at least one intensity maximum with decreasing intensities with increasing spatial distance from the maximum. The deviations of the intensities from the average intensity or a mean value of the intensity over a considered range or along a line, in particular a straight line, are therefore relatively large in comparison with a homogenized intensity profile. In the case of a “top hat” intensity profile, for example, the spatial progression of the intensities over a considered range or along a considered line is almost constant and thus corresponds to the mean value of the intensity profile of the considered range or to the mean value of the intensity profile along a considered line.

In one advantageous configuration of various embodiments, the optical element is embodied as a dichroic mirror, wherein the first and second base areas are arranged parallel to one another and opposite one another. In this case, the base areas are preferably at a distance from one another which is significantly smaller than the dimensions of the base areas, in particular the length and width thereof. This design as a beam splitter lamina thus enables extremely compact arrangements with regard to other elements, such as, for example, projection elements, light sources or optical elements in projection arrangements.

In a further configuration of various embodiments, the surface structure of the second area is designed to bring about light scattering of incident light according to a statistical distribution at least in one direction.

In this case, the surface structure can be designed for example in the form of a roughening of the surface. This may constitute a particularly simple and cost-effective configuration of the optical element, e.g. in order to bring about statistically distributed light scattering. In this case, the magnitude of the scattering can be determined by the type and configuration of the roughening of the surface. The intensity profile of a light beam impinging on the second base area of the optical element can thus be expanded, wherein expansion to different extents in different directions is also possible. Furthermore, as a result of the scattering of the light and the light mixing brought about thereby, at the same time a homogenization of the intensity distribution is also brought about.

In a further configuration of various embodiments, the surface structure of the second side is embodied as a micro lens structure having a plurality of micro lenses. The embodiment of the surface as a micro lens array may make it possible to control the beam shaping in an advantageous manner. Furthermore, an even better and more targeted homogenization is made possible as a result. In this case, the micro lens structure will be completely described by material, thickness, facet size of the micro lenses, number of facets or number of micro lenses, radius of curvature of facets and coating. In this case, the lenses can be embodied in both convex and concave fashion. Thus, the optical element can be suitably coordinated with any application with regard to the beam-shaping properties and a large number of configuration possibilities are afforded.

In one configuration of various embodiments, a first radius of curvature of the micro lenses in a first spatial direction is different from a second radius of curvature of the micro lenses in a second spatial direction. As a result of the diverse possibilities for the configuration of the micro lenses, e.g. with regard to their radii of curvature, the shaping of the intensity distribution can be configured in any desired manner. As a result, it is possible to realize not only round or circular but also non-rotationally symmetrical distributions, such as elongate, elliptic or rectangular distributions. This may be advantageous when such an optical element is used for projection arrangements in which a desired aspect ratio, such as e.g. 16:9, is intended to be realized.

The projection arrangement according to various embodiments includes a light source, which is designed to emit light, and a wavelength conversion element, which is designed to convert light of a first wavelength into light of at least a second wavelength, and an optical element according to various embodiments or a configuration variant of this optical element according to various embodiments, which is arranged in a beam path between the light source and the wavelength conversion element.

In various embodiments, all previously mentioned features and combinations of features and also prop various embodiments advantages of the optical element according to various embodiments and the configurations thereof hold true in the same way for the optical element of the projection arrangement according to various embodiments and for the projection arrangement according to various embodiments itself, in so far as is applicable.

In this case, the wavelength conversion can be brought about by one or a plurality of phosphors. By way of example, the wavelength conversion element can also be embodied as a phosphor wheel having different phosphors in different wheel segments. In particular, said phosphors can differ in terms of their conversion wavelength, that is to say in terms of the wavelength or wavelength range into which the excitation light is converted. The phosphors can thus be designed, for example, to emit light in the red, yellow, green, etc. wavelength range. Furthermore, the light source may be designed to emit light in the blue and/or ultraviolet wavelength range, since these constitute suitable excitation wavelength ranges for most phosphors.

In one configuration of the projection arrangement according to various embodiments, the optical element is arranged in the beam path in such a way that the second base area of the optical element is inclined at an angle relative to a light beam impinging on the optical element, which angle is different from 90°. In this case, the optical element may be arranged in an angular range of between 40° and 50°, e.g. at an angle of 45°. An arrangement at an angle of 45° may be advantageous e.g. for the beam-splitting or for the beam-combining function of the optical element. Moreover, by virtue of the diverse possibilities for designing the second area of the optical element, e.g. as a result of direction-dependent beam shaping, both with regard to the homogenization and with regard to the shaping of the dimensions of the intensity distribution, it is possible to realize any desired intensity distribution on the phosphor, including in the case of an arrangement at the angle of 45° of the optical element.

In a further configuration, light emitted by the light source can be at least partly transmitted by means of the optical element, can be radiated to be incident on the wavelength conversion element and can be at least partly converted into light having a second wavelength by the wavelength conversion element, which light can be emitted from the wavelength conversion element in the direction of the optical element and can be at least partly reflected by means of the optical element.

Moreover, the wavelength conversion element can have an opening embodied in such a way that light which is emitted by the light source and is radiated to be incident on the wavelength conversion element can be at least partly transmitted through the opening.

What can thus be accomplished is that part of the light which is radiated to be incident on the wavelength conversion element and which is not converted can still be utilized, such as, for example, for the beam combination of the light beam emitted by the wavelength conversion element and the light beam transmitted through the opening of the wavelength conversion element. This enables a particularly efficient configuration of the projection arrangement since one light source, in particular with only one wavelength or light in a narrow wavelength range of the optical spectrum, such as in the blue range, for example, suffices for generating and combining light in a plurality of different wavelength ranges.

In a further configuration, the projection arrangement has a plurality of mirrors arranged in such a way that light transmitted through the opening of the wavelength conversion element can be deflected by means of the mirrors in such a way that it impinges on the optical element and is transmitted by the optical element at least partly in the same direction as light emitted from the wavelength conversion element and reflected by the optical element. A beam combination of the light deflected by the mirrors and the light emitted by the wavelength conversion element may thus be realized in an advantageous manner. Moreover, in this case the intensity distribution of the light which is emitted by the light source and impinges on the optical element can be shaped in such a way that an intensity distribution that is as advantageous as possible is provided on the wavelength conversion element, and at the same time the intensity distribution of the light which is deflected by the mirrors and impinges on the optical element can likewise be shaped or shaped for the second time in order to reduce speckle patterns, for example.

Furthermore, the light source may include a plurality of laser diodes. The latter can be embodied for example as a laser diode array which uses laser light sources of the same type and/or of different types. Furthermore, it is possible to provide additional mirrors for deflecting the light emitted by the laser diodes, by means of which mirrors the light can be directed onto the optical element via further optical elements for focusing and collimating the light.

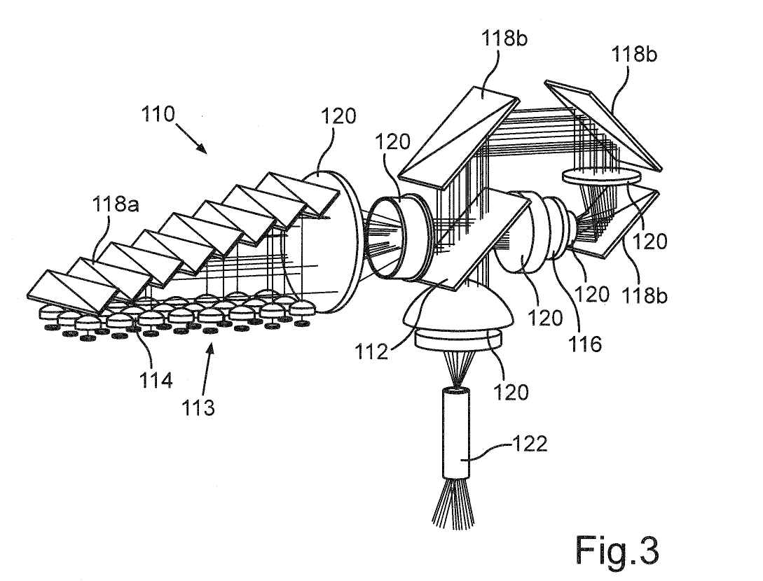

FIG. 2 shows a schematic illustration of a projection arrangement 110 in accordance with various embodiments. Furthermore, FIG. 3 shows the same arrangement in perspective illustration.

In this case, the projection arrangement 110 includes a light source 113 embodied as a laser diode array and including a plurality of laser diodes 114. Of course, other light sources can also be used, such as, for example, those which include LASER, super luminescence diodes, LEDs, organic LEDs and the like. The light source 113 is designed to emit light preferably in the blue or ultraviolet spectral range, since this constitutes a suitable excitation wavelength for most phosphors. The light from said laser diodes 114 is directed via deflection mirrors 118a onto a wavelength conversion element, which can be embodied for example as a phosphor wheel 116 including at least one phosphor arranged thereon. In this case, the phosphor wheel 116 may also include a plurality of different phosphors which are arranged in segments of the phosphor wheel 116 and, by means of the rotation of the phosphor wheel 116, can be sequentially irradiated and excitated for the emission of wavelength-converted light. In this case, the phosphor converts the incident light into light having at least one other wavelength or one other wavelength range. Furthermore, the phosphor wheel 116 can have one or a plurality of openings, such that the light incident on the phosphor wheel 116 can be partly transmitted through the phosphor wheel 116 without interacting therewith. By means of suitable deflection of this transmitting light, it can be combined with the light converted and emitted by the phosphor wheel 116, for which purpose in particular an integrator 122 can also be provided, onto which the combined beam bundle is directed. For deflecting the light transmitted through the phosphor wheel 116, e.g. three mirrors 118b are provided, which are arranged in the beam path in each case at an angle of 45° with respect to the incident light beam. Moreover, even further optical elements, e.g. in the form of lenses 120, are arranged in the beam path and essentially have a focusing and collimating effect.

In order to be able to excite the phosphor as effectively as possible and to avoid so-called quenching in the process, it is necessary to modify the pump light distribution on the phosphor in a suitable manner. In this case, the intensity profile on the phosphor should be as homogeneous as possible and completely illuminate a specific region of the phosphor.

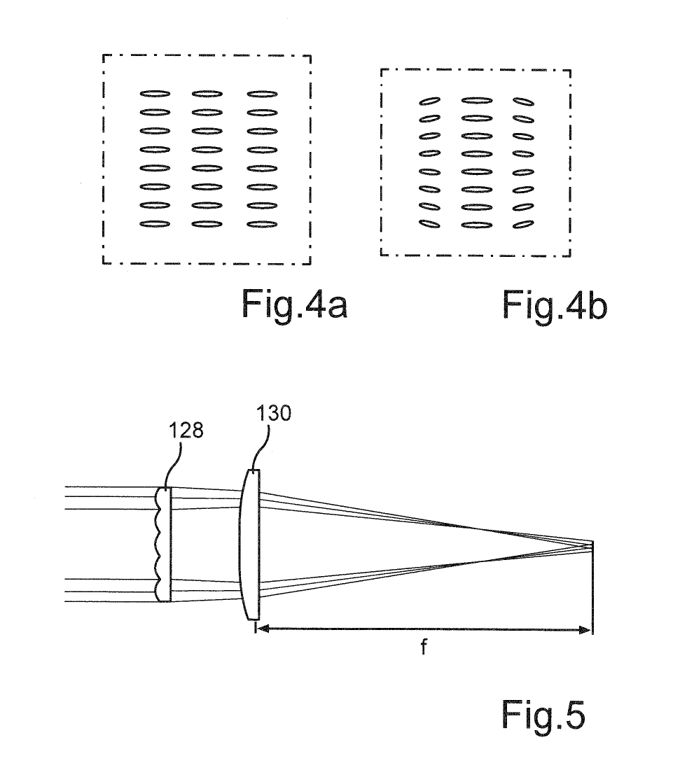

In this case, FIG. 4a and FIG. 4b illustrate by way of example two intensity distributions in a cross section through the lines A and B depicted in FIG. 2. In this case, the cross section through the line A shows the intensity distribution of the laser diode array directly after deflection by the deflection mirrors and the cross section through the line B shows the intensity distribution of the laser diode array after passage through a focusing and collimating lens arrangement 120 upstream of the optical element 112. This strongly intensity-modulated radiation field of a plurality of superimposed laser diodes 114 then needs to be homogenized.

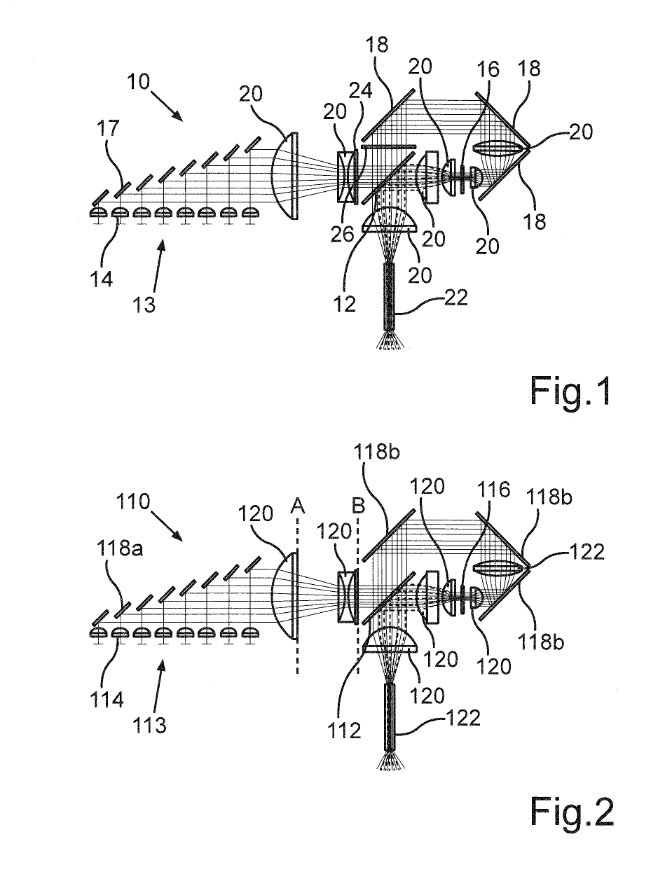

In order therefore to suitably shape the intensity distribution on the phosphor, a plurality of additional optical elements having a light-scattering or beam-shaping effect are required in the prior art. In this regard, as illustrated in FIG. 1, a first diffuser 24 is arranged upstream of the dichroic mirror 12 in order, by means of the scattering of the excitation light, to generate an expanded intensity profile with a correspondingly smaller intensity maximum on the phosphor. In order also to obtain a further homogenization of the deflected light and in particular to reduce speckle patterns, a second diffuser 26 is arranged in the beam path downstream of the deflection mirrors 18 and upstream of the dichroic mirror 12. This arrangement 10 has, for example, only light-scattering optical units, that is to say the two diffusers 24 and 26. In order furthermore also to be able to realize targeted beam shaping, even further optical units, such as micro lens arrays, for example, would be required and would likewise also have to be arranged in addition in the beam path.

Various embodiments may now make it possible to be able to realize such shaping of the intensity profile without additional optical elements. For this purpose, in accordance with various embodiments, and as illustrated in FIG. 2 and FIG. 3, an optical element 112 is arranged in the beam path between the light source 113 and the phosphor wheel 116. Said optical element includes a first and a second planar base area, which here are arranged opposite one another, parallel to one another and at a distance to one another. Furthermore, the first base area has a coating, which is designed to transmit light in a first wavelength range and to reflect light in a second wavelength range, which is different from the first wavelength range. In this exemplary application, the first base area preferably faces the wavelength conversion element, e.g. at an angle of 45°. Furthermore, a surface structure is arranged at the second base area of the optical element 112, said surface structure being formed integrally with the base area. In this case, the surface structure is designed to shape an intensity profile of a light beam impinging on the surface structure of the optical element 112. Consequently, the optical element 112 functions firstly as a beam splitter, in this case as a dichroic mirror, and secondly as an intensity-distribution-shaping optical element 112. Thus, no further optical units, neither light-scattering nor beam-shaping optical units, are required in order to obtain a shaping of the intensity profile. In various embodiments, the embodiment of a projection arrangement as illustrated in FIG. 2 and FIG. 3 may also be advantageous since the light emitted by the light source 113 passes twice through the optical element 112 in the case of such an arrangement in the beam path. In this regard, said light upon first passing through the optical element 112 can be suitably shaped for bringing about an intensity profile that is as suitable as possible at the location of the phosphor or phosphor wheel 116, and said light upon passing through the optical element 112 the second time, that is to say after deflection by the mirrors 118b, can additionally also be suitably shaped for obtaining an intensity profile that is as homogeneous as possible in the case of the combination of the two light beams, that is to say of the deflected light and of the light emitted by the phosphor wheel 116, at the location of the integrator 122.

In this case, the configuration of the surface structure of the second area of the optical element 112 can be adapted to the respective application. In this case, the shaping of the intensity profile can be effected by diverse configurations and in diverse ways.

By way of example, the surface structure can be embodied as a scattering area. Ideally, this embodiment of the surface structure can be realized by a method which enables an antireflective characteristic despite increased roughness, such as by hot embossing, for example, whereby very small local spatial gradients of the surface constitution can be achieved. In the case of this projection arrangement 110 illustrated by way of example, the scattering area in this case simultaneously influences the pump path, that is to say the light which is radiated from the light source 113 onto the optical element 112 and which is directed onto the phosphor wheel 116, and simultaneously also influences the deflected light path, that is to say the light which is transmitted through the opening of the phosphor wheel 116 and is deflected by the mirrors 118b and impinges again on the optical element 112. Thus, two optical elements required in the prior art for the purpose of beam shaping and usually embodied as diffusers 24, 26 can immediately be omitted in this example.

In this case, the scattering effect of the optical element 112 can also be embodied for example in a spatially anisotropic or direction-dependent manner. As a result, it is possible to realize e.g. a non-rotationally symmetrical distribution by means of scattering. In the case of application aspect ratios of 4:3, for example, a round distribution is still tenable; for higher aspect ratios (e.g. 16:9), an elongate, elliptic or ideally rectangular distribution may be provided, which can be realized very simply by means of a spatially anisotropic embodiment of the surface structure of the second area of the optical element 112. In this case, the spatial anisotropy of the scattering effect can be configured such that stronger scattering is brought about in a first direction than in a second direction, which is different from the first direction. By way of example, a different scattering strength can be implemented in the direction of a length of the optical element 112 than in the direction of a width of the optical element 112. In this case, the first and second directions need not necessarily be perpendicular to one another. Furthermore, the anisotropy of the scattering effect can also be configured in such a way that, for example, the scattering brought about in a region of a maximum intensity of the light impinging on the optical element 112 is stronger than the scattering brought about further away from this intensity maximum. Furthermore, the arrangement of phosphor wheel 116 and integrator 122 is preferably chosen such that the orientation of the resulting beam profiles for the converted light at the integrator input and the non-converted, deflected light at the integrator input is approximately the same.

In a further possibility for the configuration of the optical element 112, the second base area of the optical element 112 is provided with a plurality of micro lenses, for example in the form of a micro lens array.

FIG. 5 illustrates a basic schematic diagram of the functioning of a lens array 128. In various embodiments, this depicts the schematic diagram of a non-imaging homogenizer with a lens array 128 and a focusing Fourier lens 130. In this case, light incident on different regions of the lens array 128 on the object side is imaged onto a common image region in the image plane, which is situated at a distance from the Fourier lens 130 which corresponds to the focal length f thereof. It is thus possible to compensate for intensity differences in different object-side regions in the image plane.

By integrating this function into the optical element 112, e.g. by embodying the second area as a micro lens array, it is thus possible, in a particularly simple manner, to realize simultaneously a homogenization and a for example approximately rectangular beam profile at the phosphor. For this purpose, it is possible to correspondingly adapt the aspect ratio of the individual micro lenses with a constant radius of curvature or the radii of curvature of the micro lenses can be embodied differently in two spatial directions (toric lenses). The micro lenses can also be produced from a gradient-index material (GRID). Furthermore, the lens shape can be embodied as convex or concave. In this projection arrangement 110, the micro lens array also serves simultaneously for homogenizing the pump path and for homogenizing the non-converted, deflected light. In various embodiments, here as well the orientation of the micro lenses, of the intensity distribution of the excitation light on the phosphor wheel 116, the orientation of the phosphor wheel 116 itself and of the integrator 122 are coordinated with one another in order to obtain the best possible efficiency.

Depending on the application, manufacturing method and degree of homogenization sought, the edge length of an individual micro lens is preferably in a range of 0 3 mm to 3 mm, wherein these numbers are not intended to represent sharply defined limits. In the case of small micro lenses, the losses as a result of the non-ideal boundary between two micro lenses become dominant; in the case of large micro lenses, the degree of possible homogenization decreases. Therefore, an individual optimization to the respective overall system may be advantageous.

Furthermore, the surface structure of the second area of the optical element 112 can also be configured as a combination of the embodiments mentioned. By way of example, the second base area can have a roughening and at the same time include a plurality of micro lenses, e.g. such that the surface structure is embodied simultaneously as a diffuser having light-scattering properties and as a micro lens array for shaping an intensity profile in a targeted manner. Moreover, the surface structure can also have an antireflection layer in order to achieve a maximum transmission for the impinging light and thus to reduce radiation losses. In this case, said antireflection layer can be embodied as a broadband antireflection layer in order to achieve a maximum transmission for the entire visible spectrum, under certain circumstances including the UV range. Since, in various embodiments, the second base area of the optical element faces away from the phosphor wheel 116, and the antireflection layer of the second area thus has no influence on the converted light emitted by the phosphor wheel 116, a broadband antireflection layer is possible and also one which is coordinated with the excitation light wavelength, e.g. an antireflection layer for blue and/or UV.

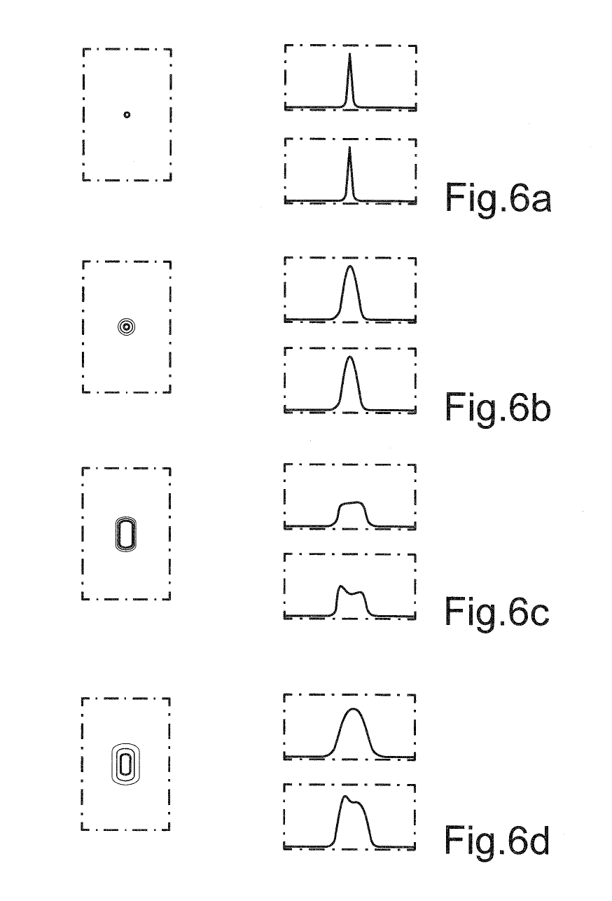

FIG. 6a to FIG. 6d show schematic illustrations of intensity distributions on a wavelength conversion element of different projection arrangements. Here in each case the depictions on the left illustrate the intensity distributions in the plane of the phosphor and the depictions on the right illustrate the intensity profiles in a horizontal (top) and vertical (bottom) cross section through the intensity distributions respectively illustrated on the left.

In this case, FIG. 6a shows an intensity distribution of a conventional projection arrangement 10 without light-scattering and beam-shaping optical elements, e.g. without the diffusers 24 and 26 illustrated in FIG. 1. In this case, the intensity distribution exhibits a very strong peak around a central maximum, which has the effect that the phosphor is heated very greatly at the location of this maximum, which reduces the conversion efficiency. Moreover, the intensity distribution also remains restricted to a very small range, which is likewise very inefficient with regard to the luminous efficiency.

By contrast, FIG. 6b shows an intensity distribution on a wavelength conversion element of a projection arrangement 110 with an optical element 112 having light-scattering properties in accordance with various embodiments. By way of example, such a distribution can be generated with an optical element 112 whose second side has a surface structure in the form of a roughening. By means of the light-scattering property, it is possible to suitably expand the intensity distribution at the location of the phosphor, with the result that firstly this enables the phosphor to be excited over a larger area, and secondly it is possible to prevent the phosphor from being heated to an excessively great extent in the region of the intensity maximum.

FIG. 6c shows an intensity distribution on the wavelength conversion element of a projection arrangement 110 with an optical element 112 whose second base area is embodied with a surface structure configured as a micro lens array, in accordance with various embodiments. Such an embodiment of the optical element 112 makes it possible to obtain an approximately rectangular intensity profile both in the vertical direction and in the horizontal direction. In this case, the length and width of this rectangular “top hat” intensity distribution can be predefined by the configuration of the micro lenses and the arrangement thereof. Consequently, firstly the desired area to be irradiated of the phosphor can be predefined in terms of its geometrical configuration, and at the same time a particularly homogeneous illumination of said area can be achieved.

FIG. 6d shows an intensity distribution on the wavelength conversion element of a projection arrangement 110 with an optical element 112 which has a second base area having a micro lens array and additionally light-scattering properties, in accordance with various embodiments. By virtue of this configuration, it is possible, as in FIG. 6c, also to achieve a rectangular intensity distribution at the location of the phosphor, wherein the horizontal and vertical progressions of the intensity profiles, as a result of the simultaneous light-scattering property of the optical element 112, are depicted somewhat more expertly and exhibit a somewhat more continuous progression than in FIG. 6c.

The diverse possibilities for the configuration of the optical element 112 therefore enable a large number of intensity distributions to be realized, some of which are illustrated by way of example as in FIG. 6b to FIG. 6d. The optical element 112 thus enables intensity profiles to be suitably shaped and e.g. homogenized, depending on the application.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An optical element, comprising:
a first planar base area; and
a second planar base area;
wherein the first base areas and second base areas do not lie in a same plane;
wherein the first base area has a coating, which is designed to reflect or transmit an electromagnetic wave according to a predefined criterion;
wherein the predefined criterion concerns a property of the electromagnetic wave which is different from an intensity;
wherein a surface structure is arranged at the second base area of the optical element, said surface structure being formed integrally with the base area; and
wherein the surface structure is designed to shape an intensity profile of a light beam impinging on the surface structure of the optical element.

2. The optical element of claim 1,
wherein the property concerns a wavelength or a polarization of the electromagnetic wave.

3. The optical element of claim 1,
wherein the surface structure is designed in such a way that when light is incident on a region of the surface structure of the optical element, a deflection of the light with deflection angles which are location-dependent is brought about.

4. The optical element of claim 1,
wherein the surface structure of the second area of the optical element is designed to homogenize the intensity profile of a light beam impinging on the surface structure of the optical element.

5. The optical element of claim 1,
wherein the surface structure of the optical element is designed in such a way that when light is incident on the surface structure, which light has a first intensity profile in a plane parallel to the second base area on a first straight line having a first length in a first direction, light emitted from the second base area has a second intensity profile on a straight line having the first length parallel to the first straight line, wherein a ratio of a sum of all deviations in terms of absolute values of the intensities from the mean intensity to the mean intensity of the first intensity profile is greater than that of the second intensity profile.

6. The optical element of claim 1,
wherein the optical element is embodied as a dichroic mirror, wherein the first and second base areas are arranged parallel to one another and opposite one another.

7. The optical element of claim 1,
wherein the surface structure of the second base area is designed to bring about light scattering of incident light according to a statistical distribution at least in one direction.

8. The optical element of claim 1,
wherein the surface structure of the second base area is embodied as a micro lens structure having a plurality of micro lenses.

9. The optical element of claim 8,
wherein a first radius of curvature of the micro lenses in a first spatial direction is different from a second radius of curvature of the micro lenses in a second spatial direction.

10. A projection arrangement, comprising:
a light source, which is designed to emit light;
a wavelength conversion element, which is designed to convert light of a first wavelength into light of at least a second wavelength; and
an optical element, which is arranged in a beam path between the light source and the wavelength conversion element, the optical element comprising:
a first planar base area; and
a second planar base area;
wherein the first base areas and second base areas do not lie in a same plane;
wherein the first base area has a coating, which is designed to reflect or transmit an electromagnetic wave according to a predefined criterion;
wherein the predefined criterion concerns a property of the electromagnetic wave which is different from an intensity;
wherein a surface structure is arranged at the second base area of the optical element, said surface structure being formed integrally with the base area; and
wherein the surface structure is designed to shape an intensity profile of a light beam impinging on the surface structure of the optical element.

11. The projection arrangement of claim 10,
wherein the optical element is arranged in the beam path in such a way that the second base area of the optical element is inclined at an angle relative to a light beam impinging on the optical element, which angle is different from 90°.

12. The projection arrangement of claim 10,
wherein light emitted by the light source can be at least partly transmitted by means of the optical element, can be radiated to be incident on the wavelength conversion element and can be at least partly converted into light having a second wavelength by the wavelength conversion element, which light can be emitted from the wavelength conversion element in the direction of the optical element and can be at least partly reflected by means of the optical element.

13. The projection arrangement of claim 10,
wherein the wavelength conversion element has an opening embodied in such a way that light which is emitted by the light source and is radiated to be incident on the wavelength conversion element can be at least partly transmitted through the opening.

14. The projection arrangement of claim 13,
wherein the projection arrangement has a plurality of mirrors arranged in such a way that light transmitted through the opening of the wavelength conversion element can be deflected by means of the mirrors in such a way that it impinges on the optical element and is transmitted by the optical element at least partly in the same direction as light emitted from the wavelength conversion element and reflected by the optical element.

15. The projection arrangement of claim 10,
wherein the light source comprises a plurality of laser diodes.
